(19) United States
(12) Patent Application Publication
(10) Pub. No.: US 2021/0062821 A1
(43) Pub. Date: Mar. 4, 2021

(54) IMPELLER AND CENTRIFUGAL COMPRESSOR

(71) Applicant: MITSUBISHI HEAVY INDUSTRIES COMPRESSOR CORPORATION, Tokyo (JP)

(72) Inventors: Nobuyori Yagi, Tokyo (JP); Akihiro Nakaniwa, Tokyo (JP); Hiroaki Oka, Hiroshima-shi (JP)

(73) Assignee: MITSUBISHI HEAVY INDUSTRIES COMPRESSOR CORPORATION, Tokyo (JP)

(21) Appl. No.: 17/004,501

(22) Filed: Aug. 27, 2020

(30) Foreign Application Priority Data
Aug. 29, 2019 (JP) 2019-156984

(51) Int. Cl. F04D 29/28; F04D 29/053; F04D 29/42

(52) U.S. Cl. CPC F04D 29/284; F04D 29/053; F05D 2240/60; F05D 2240/303; F04D 29/4226

(57) ABSTRACT

An impeller includes: a disk which is supported so as to be rotatable around an axis and which includes an outer peripheral surface expanding toward an outside in a radial direction of the disk as it goes to one side in an axial direction of the axis; a plurality of blades which are arranged on the outer peripheral surface of the disk at intervals in a circumferential direction of the disk; and a cover which is disposed at a position facing the outer peripheral surface of the disk so as to cover the plurality of blades. A leading edge of the blade includes: a straight portion which extends so as to be close to one side in the axial direction from the cover toward the disk; and a scooped portion which is receded in relation to the straight portion and of which at least a portion close to the disk is formed in an arc shape when viewed from the circumferential direction.

### BACKGROUND OF THE INVENTION

### Field of the Invention

The present disclosure relates to an impeller and a centrifugal compressor.

Priority is claimed on Japanese Patent Application No. 2019-156984, filed on Aug. 29, 2019, the content of which is incorporated herein by reference.

### Related Art

As an impeller used in a centrifugal compressor, a so-called cover type impeller is known. As an example, as described in Japanese Unexamined Patent Application, First Publication No. 2014-234803, this kind of impeller includes a disk, a blade, and a cover. An outer peripheral surface of the disk extends toward an outside in a radial direction as it goes toward one side in an axial direction. A plurality of the blades are provided on this outer peripheral surface so as to be arranged at intervals in a circumferential direction. The cover covers these blades from the outside in the radial direction.

A centrifugal force is generated with the rotation of the impeller during the operation of the centrifugal compressor. Due to the centrifugal force, high stress is generated at both edges of the blade (that is, a disk side edge and a cover side edge). When such stress is constantly applied to the blade, there is concern that a stable operation of the centrifugal compressor may be hindered. In other words, an operable rotation speed range of the centrifugal compressor is determined by using this stress distribution as one indicator. Here, in some cases, the thickness of the blade may be increased to increase the rigidity and expand the operable rotation speed range.

### SUMMARY OF THE INVENTION

However, when the thickness of the blade is just enlarged as described above, there is a possibility that performance of the centrifugal compressor may be deteriorated. In order to make up for this deterioration in performance, it is necessary to totally review the shape and the dimensions of each part.

The present disclosure has been made to solve the above-described problems and an object thereof is to provide an impeller and a centrifugal compressor in which an operable rotation speed range is enlarged by reducing stress with a simpler configuration.

In order to solve the above-described problems, an impeller according to the present disclosure includes: a disk which is supported so as to be rotatable around an axis and which includes an outer peripheral surface expanding toward an outside in a radial direction of the disk as it goes to one side in an axial direction of the axis; a plurality of blades which are arranged on the outer peripheral surface of the disk at intervals in a circumferential direction of the disk; and a cover which is disposed at a position facing the outer peripheral surface of the disk so as to cover the plurality of blades. A leading edge of the blade includes: a straight portion which extends so as to be close to one side in the axial direction from the cover toward the disk; and a scooped portion which is receded in relation to the straight portion and of which at least a portion close to the disk is formed in an arc shape when viewed from the circumferential direction.

A centrifugal compressor according to the present disclosure includes: a rotation shaft which extends along the axis; the impeller which is fixed to the rotation shaft; and a casing which covers the rotation shaft and the impeller from an outer peripheral side.

According to the impeller and the centrifugal compressor of the present disclosure, it is possible to enlarge an operable rotation speed range by reducing stress with a simpler configuration.

### BRIEF DESCRIPTION OF THE DRAWINGS

FIG. 1 is a cross-sectional view showing a configuration of a centrifugal compressor according to a first embodiment of the present disclosure.

FIG. 2 is a view in which an impeller according to the first embodiment of the present disclosure is viewed from a circumferential direction.

FIG. 3 is a view in which an impeller according to a second embodiment of the present disclosure is viewed from a circumferential direction.

FIG. 4 is a view in which an impeller according to a modified example of the present disclosure is viewed from a circumferential direction.

### DETAILED DESCRIPTION OF THE INVENTION

### First Embodiment

(Configuration of Centrifugal Compressor)

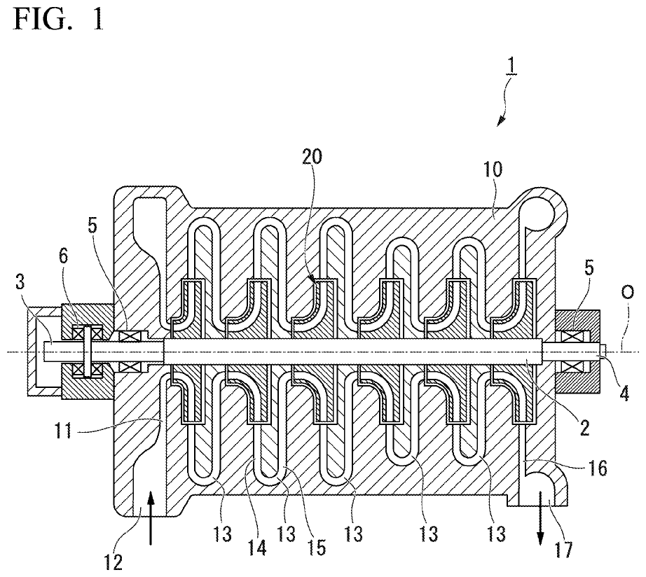

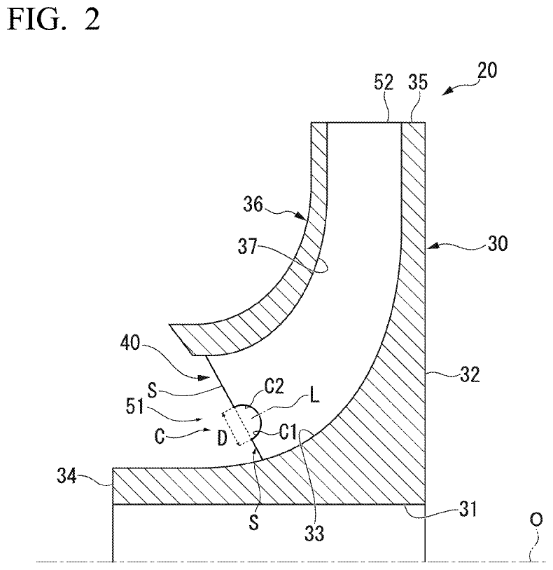

Hereinafter, a centrifugal compressor 1 according to a first embodiment of the present disclosure will be described with reference to FIGS. 1 and 2. As shown in FIG. 1, the centrifugal compressor 1 includes a rotation shaft 2, a journal bearing 5, a thrust bearing 6, an impeller 20, and a casing 10. The centrifugal compressor 1 of this embodiment is a so-called single-shaft multi-stage centrifugal compressor having a plurality of rows of impellers 20.

The rotation shaft 2 has a cylindrical shape extending in the direction of an axis O along the horizontal direction. The rotation shaft 2 is supported by the journal bearing 5 so as to be rotatable around the axis O on one portion close to a first end portion 3 in the direction of the axis O (one side in the direction of the axis O) and of the other portion close to a second end portion 4 (the other side in the direction of the axis O). In the rotation shaft 2, the first end portion 3 is supported by the thrust bearing 6.

The impellers 20 are externally fitted to the outer peripheral surface of the rotation shaft 2 and are provided in a plurality of stages at intervals in the direction of the axis O. These impellers 20 rotate around the axis O along with the rotation shaft 2 to pressure-feed a gas (fluid) flowing from the direction of the axis O toward the outside in the radial direction. The detailed configuration of the impeller 20 will be described later.

The casing 10 is a cylindrical member and accommodates the rotation shaft 2, the impeller 20, the journal bearing 5, and the like. The casing 10 is formed so as to support the rotation shaft 2 through the journal bearing 5 in a rotatable manner. Accordingly, the impeller 20 attached to the rotation shaft 2 is relatively rotatable with respect to the casing 10. The casing 10 includes an introduction passage 11, a connection passage 13, and a discharge passage 16.

The introduction passage 11 introduces a gas from the outside of the casing 10 to the frontmost-stage impeller 20 disposed on the most other side in the direction of the axis O among the plurality of impellers 20. The introduction passage 11 opens to the outer peripheral surface of the casing 10 and the opening portion is a gas inlet 12. The introduction passage 11 is connected to the other side in the direction of the axis O of the frontmost-stage impeller 20 at a portion on the inside in the radial direction.

The connection passage 13 is a passage which connects a pair of the impellers 20 adjacent to each other in the direction of the axis O. The connection passage 13 introduces a gas discharged from the impeller 20 on the front side toward the outside in the radial direction into the impeller 20 on the rear side from the other side in the direction of the axis O. The connection passage 13 includes a diffuser passage 14 and a return passage 15.

The diffuser passage 14 is connected to the outside of the impeller 20 in the radial direction and converts velocity energy into pressure energy while guiding a gas, discharged from the impeller 20 toward the outside in the radial direction, toward the outside in the radial direction. The return passage 15 is connected to the outside of the diffuser passage 14 in the radial direction and diverts a gas directed toward the outside in the radial direction to the inside in the radial direction so that the gas is guided to the impeller 20 at the rear side.

The discharge passage 16 discharges a gas, discharged from the rearmost-stage impeller 20 disposed on the most other side in the direction of the axis O among the plurality of impellers 20 toward the outside in the radial direction, toward the outside of the casing 10. The discharge passage 16 opens to the outer peripheral surface of the casing 10 and the opening portion is a gas outlet 17. The discharge passage 16 is connected to the outside of the rearmost-stage impeller 20 in the radial direction at a portion on the inside in the radial direction.

(Configuration of Impeller)

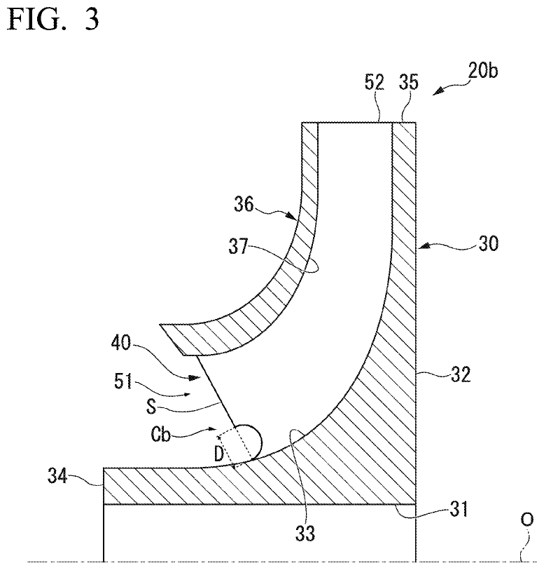

Next, the detailed configuration of the impeller 20 will be described with reference to FIGS. 2 and 3. The impeller 20 includes a disk 30, a blade 40, and a cover 36.

The disk 30 is formed in a disk shape around the axis O. The disk 30 is provided with a through-hole 31 which is formed in a circular shape around the axis O and penetrates the disk in the direction of the axis O. The inner surface of the through-hole 31 is fitted into the outer peripheral surface of the rotation shaft 2, so that the impeller 20 is integrally fixed to the rotation shaft 2.

A surface facing the other side in the direction of the axis O of the disk 30 is a disk rear surface 32 having a planar shape orthogonal to the axis O. A disk main surface 33 is formed from an end portion of the through-hole 31 of the disk 30 on the other side in the direction of the axis O to an end portion of the disk rear surface 32 on the outside in the radial direction so as to gradually expand toward the outside in the radial direction from one side to the other side in the axial direction. In the disk main surface 33, a portion on the other side in the direction of the axis O faces the outside in the radial direction and the disk main surface is gradually curved toward the other side in the direction of the axis O as it goes toward one side in the direction of the axis O. That is, the disk main surface 33 is gradually enlarged in diameter from the other side toward one side in the direction of the axis O. The disk main surface 33 has a concave curved surface shape.

In this embodiment, a disk front end surface 34 which is formed in a planar shape orthogonal to the direction of the axis O is formed between an end portion on the other side in the direction of the axis O of the disk main surface 33 and an end portion on one side in the direction of the axis O of the through-hole 31. A disk outer end surface 35 which extends in the direction of the axis O and is an outer edge portion of the disk 30 is formed between an end portion on one side in the direction of the axis O of the disk main surface 33 and an end portion on the outside in the radial direction of the disk rear surface 32.

A plurality of the blades 40 are provided in the disk main surface 33 of the disk 30 at intervals in the circumferential direction of the axis O. Each blade 40 is curved toward the rear side in the rotation direction R of the impeller 20 (one side in the circumferential direction) as it goes from the inside in the radial direction toward the outside in the radial direction. Each blade 40 extends while forming a protruding curved surface protruding toward the front side in the rotation direction R. A passage which communicates with the introduction passage 11 and the connection passage 13 is formed between a pair of the blades 40 adjacent to each other.

A leading edge 51 of the blade 40 is disposed at a position adjacent to the end portion on the other side of the cover 36 in the direction of the axis O. The leading edge 51 is formed by a straight portion S and a scooped portion C. The straight portion S extends so as to be one side in the direction of the axis O from the cover 36 toward the disk 30. The scooped portion C is receded in relation to the middle position of the straight portion S. The scooped portion C is formed in an arc shape when viewed from the circumferential direction. An end portion close to the disk 30 in the scooped portion C is located at a position separated from the outer peripheral surface (the disk main surface 33) of the disk 30 toward the cover 36.

The scooped portion C can be divided into a first portion C1 located close to the cover 36 and a second portion C2 located close to the disk 30 with respect to an equal line L passing through the center point of the scooped portion C and orthogonal to the leading edge 51. In this embodiment, the first portion C1 and the second portion C2 are formed in an arc shape so as to be continuous to each other. In the scooped portion C, the first portion C1 may be formed in a shape (for example, a rectangular shape) other than an arc shape. On the other hand, the second portion C2 is formed in an arc shape regardless of the shape of the first portion C1.

Further, the extension dimension D of the scooped portion C (that is, the dimension of the scooped portion C from one end portion close to the cover to the other end portion close to the disk: arc diameter) is set to 50% or less when the dimension of the entire leading edge 51 is 100%. More preferably, this dimension D is set to 40% or less of the entire leading edge 51. Most preferably, the dimension D is set to 30% or less of the entire leading edge 51.

The cover 36 covers the plurality of blades 40 from the outer peripheral side. The cover 36 is provided to face the disk 30 so that the blade 40 is interposed between the cover and the disk 30. The inner peripheral surface 37 of the cover 36 is formed so as to be gradually enlarged in diameter as it goes from the other side toward one side in the direction of the axis O. The inner peripheral surface 37 of the cover 36 is curved similarly to the disk main surface 33 so as to correspond to the disk main surface 33. An end portion opposite to the disk main surface 33 in the blade 40 is fixed to the inner peripheral surface 37 of the cover 36.

A passage is formed by the inner peripheral surface 37 of the cover 36, the disk main surface 33, and the blade 40 so as to be located therebetween so that the passage extends so as to be curved toward the rear side in the rotation direction R as it goes from one side toward the other side in the direction of the axis O.

(Operation and Effects)

Next, the operation of the centrifugal compressor 1 will be described. When driving the centrifugal compressor 1, the rotation shaft 2 is first rotated by an external power source. The impeller 20 rotates together with the rotation of the rotation shaft 2. Accordingly, an external fluid is received into the centrifugal compressor 1 through the introduction passage 11. The fluid is compressed while flowing through the passage formed between the blades 40 of the impeller 20 so as to become a high-pressure fluid and flows into the connection passage 13. The fluid flowing into the connection passage 13 is further compressed by the impeller 20 at the rear side. Such a cycle is repeated until the fluid reaches the impeller 20 at the final row and finally the fluid having a target pressure is discharged from the discharge passage 16.

Incidentally, a centrifugal force is generated with the rotation of the impeller 20 during the operation of the centrifugal compressor 1. Due to the centrifugal force, high stress is generated at both edges of the blade 40 (that is, an edge close to the disk 30 and an edge close to the cover 36). When such stress is constantly applied to the blade 40, there is concern that a stable operation of the centrifugal compressor 1 may be hindered. In other words, the operable rotation speed range of the centrifugal compressor 1 is determined by using this stress distribution as one index. Here, in this embodiment, the leading edge 51 of the blade 40 is provided with the straight portion S and the scooped portion C.

According to the above-described configuration, the rigidity of the portion provided with the scooped portion C is lower than that of the other portion (the straight portion S). Thus, when the centrifugal force generated with the rotation of the impeller 20 is applied to the blade 40, most of the stress concentrates on the portion provided with the scooped portion C. In other words, the stress generated at the end portion close to the disk 30 or the end portion close to the cover 36 in the leading edge 51 of the blade 40 can be reduced to a low level. As a result, the durability of the impeller 20 against a centrifugal force can be increased. As a result, the operable rotation speed range of the centrifugal compressor 1 can be enlarged.

According to the above-described configuration, since the scooped portion C is formed in an arc shape as a whole, the concentration of local stress can be reduced compared to, for example, a case in which the scooped portion C is formed in a rectangular shape. In other words, the stress distribution in the corresponding portion can be moderated. Thus, the stress distribution can be made uniform inside the scooped portion C while actively concentrating the stress on the scooped portion C in the entire leading edge 51.

According to the above-described configuration, since the end portion close to the disk 30 in the scooped portion C is located at a position separated from the outer peripheral surface of the disk 30 toward the cover 36, it is possible to concentrate the stress on the scooped portion C while ensuring the rigidity of the blade 40.

### Second Embodiment

Next, a second embodiment of the present disclosure will be described with reference to FIG. 3. Additionally, the same components as those of the first embodiment will be denoted by the same reference numerals and detailed description thereof will be omitted. As shown in the same drawing, in this embodiment, the configuration of an impeller 20b is different from that of the first embodiment.

In the impeller 20b, a portion close to the cover 36 in the leading edge 51 is formed as a straight portion S and a portion close to the disk 30 in relation to the straight portion S is formed as a scooped portion Cb. That is, an end portion on the inside in the radial direction of the scooped portion Cb (an end portion close to the disk 30) is in contact with the outer peripheral surface (the disk main surface 33) of the disk 30.

The extension dimension D of the scooped portion Cb (that is, the dimension of the scooped portion C from one end portion close to the cover to the other end portion close to the disk: arc diameter) is set to 10% or more and 40% or less when the entire dimension of the leading edge 51 is 100%. More preferably, this dimension D is set to 20% or more and 40% or less of the entire leading edge 51. Most preferably, the dimension D is set to 40% of the entire leading edge 51.

According to the above-described configuration, since the end portion close to the disk 30 in the scooped portion Cb is in contact with the outer peripheral surface of the disk 30, it is possible to further concentrate the stress on the scooped portion Cb while ensuring the rigidity of the blade 40.

### OTHER EMBODIMENTS

As described above, the embodiments of the present disclosure have been described in detail with reference to the drawings, but the specific configuration is not limited to the embodiments and includes design changes and the like within a range not departing from the spirit of the present disclosure.

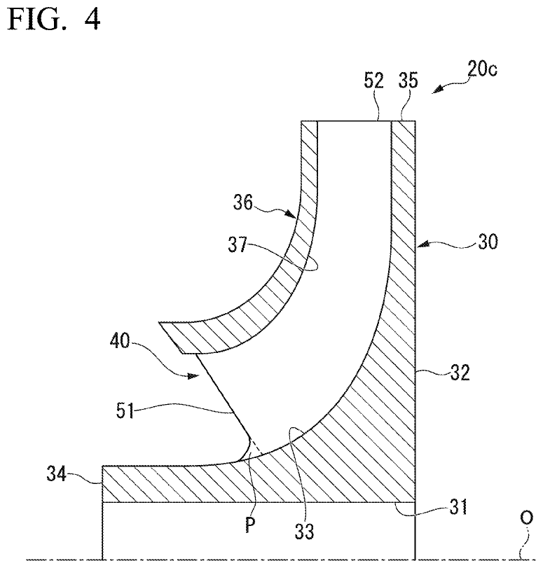

For example, as shown in FIG. 4, in an impeller 20c, a portion including an end portion close to the disk 30 in the leading edge 51 may be provided with a protrusion portion P protruding from the leading edge 51. The protrusion portion P extends toward the other side in the direction of the axis O as it goes from the outside toward the inside in the radial direction. The edge of the protrusion portion P is formed as a curved surface depressed toward the disk 30. According to such a configuration, most of the stress generated in the blade 40 can concentrate on the protrusion portion P.

### APPENDIX

The impellers of the embodiments are understood, for example, as below.

(1) An impeller according to a first aspect includes: a disk which is supported so as to be rotatable around an axis and which includes an outer peripheral surface expanding toward an outside in a radial direction of the disk as it goes to one side in an axial direction of the axis; a plurality of blades which are arranged on the outer peripheral surface of the disk at intervals in a circumferential direction of the disk; and a cover which is disposed at a position facing the outer peripheral surface of the disk so as to cover the plurality of blades, wherein a leading edge of the blade includes: a straight portion which extends so as to be close to one side in the axial direction from the cover toward the disk; and a scooped portion which is receded in relation to the straight portion and of which at least a portion close to the disk is formed in an arc shape when viewed from the circumferential direction.

According to the above-described configuration, the scooped portion (C) is formed in the leading edge (51) of each of the blades (40). Accordingly, the rigidity of the portion provided with the scooped portion (C) is lower than that of the other portion (the straight portion (S)). Thus, when the centrifugal force generated with the rotation of the impeller (20) is applied to the blade (40), most of the stress concentrates on the portion provided with the scooped portion (C). In other words, the stress generated at the end portion close to the disk (30) or the end portion close to the cover (36) in the leading edge (51) of the blade (40) can be reduced to a low level. As a result, it is possible to increase the durability of the impeller (20) against a centrifugal force.

(2) In the impeller (20) according to a second aspect, a portion of the scooped portion (C) which is close to the cover (36) is formed in an arc shape when viewed from the circumferential direction.

According to the above-described configuration, since the scooped portion (C) is formed in an arc shape as a whole, the concentration of local stress can be reduced compared to, for example, a case in which the scooped portion (C) is formed in a rectangular shape. In other words, the stress distribution at the corresponding portion can be moderated. Thus, the stress distribution in the scooped portion (C) can be made uniform while actively concentrating the stress on the scooped portion (C) in the entire leading edge (51).

(3) In the impeller (20) according to a third aspect, a first end portion of the scooped portion (C) which is close to the disk (30) is located at a position separated from the outer peripheral surface of the disk (30) toward the cover (36).

According to the above-described configuration, since the end portion close to the disk (30) in the scooped portion (C) is located at a position separated from the outer peripheral surface of the disk (30) toward the cover (36), it is possible to concentrate the stress on the scooped portion (C) while ensuring the rigidity of the blade 40.

(4) In the impeller (20) according to a fourth aspect, the length of the scooped portion (C) from the first end portion close to the disk (30) to a second end portion of the scooped portion (30) close to the cover (36) is 30% or less with respect to the length of the leading edge (51).

According to the above-described configuration, it is possible to concentrate the stress on the scooped portion (C) while ensuring the rigidity of the blade (40).

(5) In the impeller (20b) according to a fifth aspect, the first end portion of the scooped portion (Cb) close to the disk (30) is in contact with the outer peripheral surface of the disk (30).

According to the above-described configuration, since the end portion close to the disk (30) in the scooped portion (Cb) is in contact with the outer peripheral surface of the disk (30), it is possible to concentrate the stress on the scooped portion (Cb) while ensuring the rigidity of the blade (40).

(6) In the impeller (20b) according to a sixth aspect, the length of the scooped portion (Cb) from the first end portion close to the disk (30) to the second end portion close to the cover (36) is 20% or more and 40% or less with respect to a length of the leading edge (51).

According to the above-described configuration, it is possible to concentrate the stress on the scooped portion (Cb) while ensuring the rigidity of the blade (40).

(7) The centrifugal compressor (1) according to a seventh aspect includes: the rotation shaft (2) which extends along the axis (0); the impellers (20, 20b) according to any one of the above-described aspects which is fixed to the rotation shaft (2); and the casing (10) which is installed so as to cover an outside of the rotation shaft (2) and the impellers (20, 20b).

According to the above-described configuration, it is possible to further expand the operable rotation speed range of the centrifugal compressor (1) by increasing the durability of the impellers (20, 20b) against a centrifugal force.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Compressor
2 Rotation shaft
3 First end portion
4 Second end portion
5 Journal bearing
6 Thrust bearing
10 Casing
11 Introduction passage
12 Inlet
13 Connection passage
14 Diffuser passage
15 Return passage
16 Discharge passage
17 Outlet
20, 20b, 20c Impeller
30 Disk
31 Through-hole
32 Disk rear surface
33 Disk main surface
34 Disk front end surface
35 Disk outer end surface
36 Cover
37 Inner peripheral surface
40 Blade
51 Leading edge
52 Trailing edge
C, Cb Scooped portion
C1 First portion
C2 Second portion
L Equal line
O Axis
P Protrusion portion
S Straight portion

What is claimed is:

1. An impeller comprising:
a disk which is supported so as to be rotatable around an axis and which includes an outer peripheral surface expanding toward an outside in a radial direction of the disk as it goes to one side in an axial direction of the axis;
a plurality of blades which are arranged on the outer peripheral surface of the disk at intervals in a circumferential direction of the disk; and
a cover which is disposed at a position facing the outer peripheral surface of the disk so as to cover the plurality of blades,
wherein a leading edge of the blade includes:
a straight portion which extends so as to be close to one side in the axial direction from the cover toward the disk; and
a scooped portion which is receded in relation to the straight portion and of which at least a portion close to the disk is formed in an arc shape when viewed from the circumferential direction.

2. The impeller according to claim 1, wherein a portion of the scooped portion which is close to the cover is formed in an arc shape when viewed from the circumferential direction.

3. The impeller according to claim 1, wherein a first end portion of the scooped portion which is close to the disk is located at a position separated from the outer peripheral surface of the disk toward the cover.

4. The impeller according to claim 3, wherein a length of the scooped portion from the first end portion close to the disk to a second end portion of the scooped portion close to the cover is 30% or less with respect to a length of the leading edge.

5. The impeller according to claim 1, wherein the first end portion of the scooped portion close to the disk is in contact with the outer peripheral surface of the disk.

6. The impeller according to claim 5,
wherein a length of the scooped portion from the first end portion close to the disk to the second end portion close to the cover is 20% or more and 40% or less with respect to a length of the leading edge.

7. A centrifugal compressor comprising:
a rotation shaft which extends in the axial direction;
the impeller according to claim 1 which is fixed to the rotation shaft; and
a casing which is installed so as to cover an outside of the rotation shaft and the impeller.
